(19) United States
(12) Patent Application Publication
(10) Pub. No.: US 2014/0369670 A1
(43) Pub. Date: Dec. 18, 2014

(54) METHOD AND DEVICE FOR SELECTIVELY COMBINING HETEROGENEOUS DIGITAL MEDIA OBJECTS

(71) Applicant: Universitat Des Saarlandes, Saarbrucken (DE)

(72) Inventors: Thorsten Herfet, Schwarzenbruck (DE); Christopher Haccius, Saarbrucken (DE)

(21) Appl. No.: 13/917,172

(22) Filed: Jun. 13, 2013

(51) Int. Cl. H04N 5/222; H04N 5/265

(52) U.S. Cl. CPC H04N 5/2228; H04N 5/265
USPC 386/278

(57) ABSTRACT

The present disclosure relates to digital media representations. In particular the present disclosure related to computer implemented methods and devices for selectively merging several rich digital media objects into a combined media asset or object, without sacrificing the rich information represented by each individual digital media object.

### FIELD

The present disclosure relates to field of digital media representations. In particular, the present disclosure relates to a computer implemented method and a device for merging several rich digital media objects into a combined media object, without sacrificing the rich information represented by each individual digital media object.

### BACKGROUND

It is known to combine diverse digital media objects such as encoded images or videos in a production environment. However, typical production tools act directly on the source data of the digital media objects that already contain artistic elements (e.g. a limited depth of field to influence the viewer's attention or motion blur to increase the perception of dynamics). This approach implies a high computational cost and sacrifices at least a part of the information content of the media object through filtering, flattening or blurring available data layers and/or merging objects with background information.

Common video formats have only one graphics layer, which contains the visual information of the video. Post processing steps can only deal with information available in this layer, which is at the same information that is seen by a user or viewer of the video.

A further challenge that is presently not solved in a satisfactory way is the flexible integration of very heterogeneous media types, including images, video data and computer generated models, which are possibly governed by geometric parameters, into a combined scene. Available production tools do generally not allow the seamless integration of heterogeneous media objects into a scene of overall coherent appearance, when the constituting media objects originate from very diverse sources and the underlying source data has been captured or generated under very diverse conditions.

### SUMMARY

The present disclosure provides methods and devices that overcomes at least some of the disadvantages of the prior art. For example, in various embodiments, the present disclosure provides a method that allows implementation of a Scene Representation Architecture (SRA) that addresses at least some of the problems present in the prior art.

It is an object of the present disclosure to provide a computer-implemented method for selectively combining digital media objects. Each digital media object is electronically stored as a digital file, or digitally encoded from a source in real-time. The method comprises the steps of selecting digital media objects, wherein each digital media object represents media in one or more dimensions, from a set of provided digital media objects, and providing a description of a virtual space having a dimensionality at least equal to the highest dimensionality of any of the selected digital media objects, the description further specifying the positions of each selected digital media object in the virtual space. In various implementations the dimensionality of the virtual space corresponds to a superset of the dimensions of any of the selected digital media objects. The method additionally comprises providing a description of a viewpoint in the virtual space, and subsequently generating a combined digital media object, which represents the selected digital media objects at their defined positions in the virtual space, as observed from the viewpoint.

In various implementations, the description of the virtual space can specify how the selected digital media objects dynamically evolve in the virtual space over a specified time period. This can for example include changes in position, size, or the application of affine transformations.

In various implementations, the position of the viewpoint can be specified as changing within the virtual space over time. In such cases the generated combined digital media object reflects the movement of the viewpoint over time.

Each digital media object can comprise metadata, which comprises information as to how the represented media information has been captured or created.

The description of the virtual space can further specify metadata. The metadata can include information as to how selected digital media objects can be positioned relative to one another within the virtual space, in order to provide time and space coherency of the selected digital media objects in the virtual space.

The description of the virtual space can further specify properties for each digital media object. The properties can be related to the desired appearance of the digital media object within the virtual space, including but not limited to the media object's size or an affine transformation that should be applied to the media object. These properties can be applied to the digital media objects during the step of generating a combined digital media object.

The description of the viewpoint can comprise the modeling of a virtual camera, which is located at the viewpoint, the model comprising specified intrinsic and/or extrinsic camera parameters. The parameters can be applied to the viewpoint during the step of generating a combined digital media object, so that the combined digital media object appears as if the virtual space it represents had been viewed through a camera possessing the specified intrinsic and/or extrinsic properties, and being located at the viewpoint.

The method can further comprise the step of specifying, for the virtual space as viewed from the viewpoint, a signal processing effect that is applied during the step of generating a combined digital media object.

The method can still further comprise the step of specifying, for at least one selected digital media object, a signal processing effect that is applied to the digital media object during the step of generating a combined digital media object. The signal processing effect can, for example, be any known artistic and/or lossy image processing effect, as provided by known image processing algorithms.

The set of digital media objects can comprise heterogeneous media objects, including but not limited to, images, videos, still or animated computer-generated objects such as polygon meshes for example.

Each digital media object can further be electronically stored, or encoded from a source in real-time, at a quality level incurring low or no signal losses. In various implementations, the best available quality of the media data is provided by each media object.

The step of generating a combined digital media object can comprise the conversion of at least one selected digital media object into an encoding format that differs from the encoding format in which the digital media object was initially stored.

The method can further comprise a rendering step, during which a graphical representation of the generated combined media object is created. The rendered object can be displayed on a display unit or stored in a storage element.

The rendering step can require encoding, transcoding or re-encoding of at least part of the information provided by at least one of the individual media objects, in order to combine all the media objects into a single combined digital media object.

The description of the virtual space can be defined using a hierarchically structured data structure, for example a hierarchically structured file. The file can comprise a file section specifying, for each digital media object that should be included in the combined media object, its physical storage location, or any parameters that are needed to define the object. The file can comprise a section that specifies the location of the viewpoint within the virtual space, and the virtual camera properties associated to the viewpoint.

Additionally, it is an object of the present disclosure to provide a device for implementing the method described herein. The device comprises at least one memory element and processing means. The processing means are configured to load a description of a virtual space from a data file. The data file is stored in a storage element and its contents are loaded or read into the memory element. The processing means are further configured to load at least one digital media object specified in the description from a storage element into the memory element. Further, the processing means are configured to generate a combined digital media object, which represents the selected digital media objects at positions within the virtual space that are specified in the description, as observed from a specified viewpoint, and to store the digital media object in the memory element.

The device can further comprise a user interface, which enables a user to modify the description of the virtual space prior to generating a combined digital media object.

The processing means can further be configured to render a graphical representation of the combined digital media object, and to display the representation on a display unit operatively connected to the device.

The processing means can be configured to store the combined digital media object on a storage element.

It is a further object of the present disclosure to provide a computer capable of carrying out the method that has been described.

It is yet another object of the present disclosure to provide a computer program comprising computer readable code means, which when run on a computer, causes the computer to carry out the method described herein.

Finally, the present disclosure provides a computer program product comprising a computer-readable medium on which the computer program according to the disclosure is stored.

The method according to the disclosure provides an efficient and modular way to merge existing heterogeneous media representations into a combined representation. Each individual media object, for example an image or a video file, can be stored in an encoding format which most efficiently and appropriately represents the captured data. The repository of available media objects forms a conceptual base layer of props that can be combined in a virtual space, representing a conceptual scene.

A scene description in accordance with the present disclosure, or virtual space description, describes the positions of selected digital media objects with respect to one another and within the virtual space over time. However, it remains a mere description, which can be easily altered and which does not change the underlying data of any of the digital media objects. Several scene descriptions can rely on identical digital media objects and combine them in different ways, including varying their size, applying affine transforms to them, etc. A scene description can for example merge several two dimensional images into a three dimensional representation.

The definition of a specific viewpoint can be seen as a part of a conceptual Director's layer, wherein the Director has the freedom to represent the described scene as he/she pleases, he/she selects the viewing angle, the camera parameters and any parameters impacting the overall rendering of the scene. This can for example include any artistic effects applied to individual objects in the scene, or to the scene in its entirety.

Finally, it is only when the combined digital media object, which is a representation of the defined scene as seen from the defined viewpoint, is generated, that the actual data of each individual digital media object is used. The virtual space description, or scene description, is interpreted in order to generate the described scene. At this stage, the data that represents the individual media objects can for example need conversion into a different encoding format. The geometric transforms and the dimensioning properties that have been specified in the scene description are applied, and any artistic effects that are chosen by the scene's Director are applied to individual digital media objects. However, the original data relating to each individual digital media object remains unchanged and can be used in different scene representations. This outlines the general principles underlying the present disclosure, which will be further detailed by way of example only.

The proposed architecture provides the possibility of merging the media related data at a very late stage of the production of a combined media object, thereby increasing the flexibility in designing the combined media object. The architecture is modular in the sense that any media or data format can be included into a scene, provided that a suitable conversion module is made available.

According to the present disclosure, the process of defining a scene representation involves a lot of information which helps in processing steps, but which shall not be seen by the final viewer, i.e. in the combined generated object. A simple example is the following: a moving object shall be motion blurred. In a traditional video the object would be shot with camera parameters such that the object is blurred (disturbed data). Post processing of this blurred data is difficult, if not impossible. According to the present disclosure, it is possible to capture the moving object in the best possible quality (not blurred) and introduce the blur as an effect. This allows easier post processing/tracking/modification of the object.

### DRAWINGS

Several embodiments of the present disclosure are illustrated by way of figures, which do not limit the scope of the disclosure, wherein:

FIG. 1 is a schematic illustration of a conceptual architecture that can be implemented using an embodiment of a method for selectively combining digital media objects, in accordance with various embodiments of the present disclosure.

FIG. 2 is a flow diagram illustration of the principal steps of the method for selectively combining digital media objects, in accordance with various embodiments of the present disclosure.

FIG. 3 is a schematic illustration of a device for implementing method for selectively combining digital media objects, in accordance with various embodiments of the present disclosure.

### DETAILED DESCRIPTION

The following description is merely exemplary in nature and is in no way intended to limit the present teachings, application, or uses. Throughout this specification, like reference numerals will be used to refer to like elements.

Throughout the description and in the context of this disclosure, the terms “digital media object” and “acel” are used in an identical way and describe a single concept. An acel is an atomic scene element. It is defined as the smallest coherent composing element of a larger scene. The term “smallest” is in this context defined by the source encoder. A plain consumer camera for example could consider each pixel of a 2D image as an individual acel. A smarter camera with the ability to segment the image information into superpixels, could store each superpixel or segmented object as an acel. Even continuous objects, like computer generated 3D objects, can be considered as acels, or digital media objects. An acel can have an arbitrary shape and an arbitrary number of dimensions such as space, time, color and reflectance. Preferably an acel comprises media information at the highest available quality, unfiltered and ideally losslessly encoded. The data described by each acel is stored in a file type that is most appropriate for the encoded media type. However, in the context of the disclosure, it is preferred that each digital media object can be identified using a unique identifier. The concept of an acel encompasses a multitude of media types including lossless 2D/3D video, lossless computer generated imagery. Acels ideally not comprise processing that would lead to a loss of information.

Throughout the description and in the context of this disclosure, the terms “scene” and “virtual space” are used in an identical way and describe a single concept. A scene is a virtual space that comprises one or a plurality of acels, arranged in a specific way and evolving over time in a specific way. The arrangement and positioning of each acel is provided in the description of a scene description or of a virtual space.

Throughout the description and in the context of this disclosure, the expression “Scene Representation Architecture”, SRA, is used to describe a conceptual software architecture that uses the methods described herein according to the present disclosure.

The Scene Representation Architecture, SRA, is a novel architecture aimed specifically at merging real and computer generated content. Merging those two worlds at the lowest possible level is possible through a layered approach which is based on real world movie production.

The present disclosure introduces three layers: a Base Layer, a Scene Layer, and a Director's Layer. This layer-based architecture is aimed at movie production with the intention to merge real and generated content on the lowest possible level for facilitated post processing and for enhancing the final user experience.

The Base Layer is a file store, which contains all elements that can be contained in an image or video. The Base Layer represents the lowest level of the SRA. This layer stores the information as provided by different sources, which can be any kind of data acquisition equipment or computer generated content. The present disclosure introduces a new format to store this Base Layer information which is herein called acel (Atomic sCene ELements). Those acels represent the physical content of a scene. Each acel itself is consistent in all its dimensions, but independent from other acels. Coherency information regarding only the data of a single acel is already part of this acel. An acel's size can range from a single data value to a full multidimensional object.

The acels can be contributed by real image acquisition, processed data or computer generated content. Furthermore, all additional processing steps that enhance Base Layer Data are stored in the Base Layer. Thus, the Base Layer provides all objects which constitute a scene, and assures that no information is lost during processing.

The Scene Layer combines those acels in a setting, positions lights and defines which elements of the setting are coherent to each other. The Scene Layer uses the Base Layer information to define a whole scene. The independent acels stored in the Base Layer are positioned in a scene, and further information is added. Among this information is lighting information and coherency information. The coherency information creates a structure between different acels exceeding their positioning in the defined dimensions. Those coherencies provide important information for physical plausibility during post processing and user interaction.

The Scene Layer description is preferably contained in a hierarchically structured file. The file can be directly written by a user, who introduces the description in text format. Alternatively, a software program implementing the disclosure can provide a graphical user interface, GUI, that allows the user to describe the scene at a higher level. For example, the GUI represents an empty virtual space at the beginning of the process. The user selects digital media objects available from the Base Layer from a list element of the GUI, such as a drop-down box for example. The user can then drag a selected object onto the scene, and adjust its size and position using a pointing device. The user can also define a motion path for each object using a pointing device. The pointing device can be a mouse device, or a finger if the GUI is represented on a known tablet computer having a touch sensitive interface. Once the user has fully specified the scene description, the hierarchically structured textual description of the scene can be generated by the software.

Finally, the Director's Layer introduces the camera, with the artistic elements introduced by the camera operator. Additionally, the Director's Layer can allow user interaction with the scene. All layers together represent the new scene file format. The Director's Layer is the interface between the user and the SRA. The Director's layer includes information specifying a camera, through which a user experiences the scene. Director's layer also includes all kinds of information which make a movie production a piece of art, like different sorts of filters, blur or other effects. Finally, the Director's Layer can allow user interaction with a scene. By defining interaction rules the Director's Layer can provide specific options how a scene or the experience of this scene can be modified by the user.

The Director's Layer description is contained in a hierarchically structured file. The file can be directly written by a user, who introduces the description in text format. Alternatively, a software program implementing the disclosure can provide a graphical user interface, GUI, that allows the user to describe the viewpoints at a higher level. For example, the GUI represents the virtual space comprising the positions of the selected digital media objects. The user can then drag a possibly pre-defined virtual camera model template from a list element of the GUI, such as a drop-down box for example, onto scene. The user can also define a motion path for each viewpoint using a pointing device. Similarly, the user can select a digital media object present in the scene using a pointing device, and then select an image or video processing effect from a drop-down list, which will be applied to the object during the step of generating the combined media object. The pointing device can be a mouse device, or a finger if the GUI is represented on a known tablet computer having a touch sensitive interface. Once the user has fully specified the viewpoint description, the hierarchically structured textual description of the viewpoint can be generated by the software.

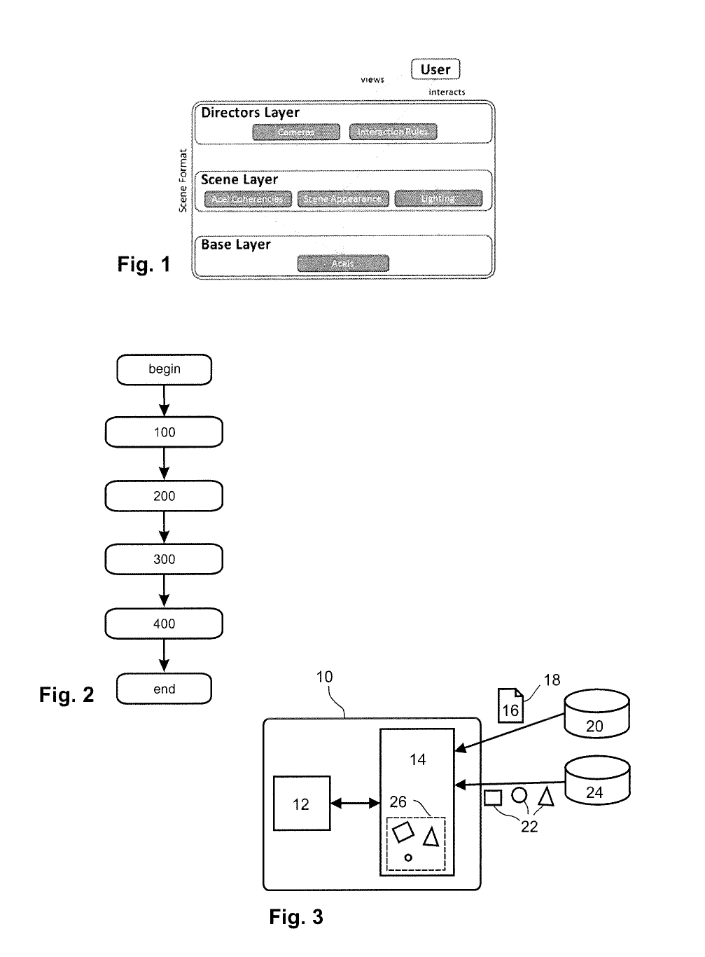

FIG. 1 represents an overview of an SRA that can be achieved using the method for selectively combining digital media objects, as described herein in accordance various embodiments of the present disclosure. The Base Layer provides the entire object information constituting a scene in the form of acels. Those acels are positioned in a scene according to the scene appearance, which is contained in the Scene Layer. This scene appearance block defines a scene for all dimensions of occurring acels and positions the acels accordingly. Furthermore, coherency information is provided in the Scene Layer. This coherency information directly relates to the acels and creates relationships between sets of those. Lighting information is also included in the Scene Layer. Unlike coherency and appearance information, lighting information does not affect individual acels, but it affects all information provided in the Base Layer. The Director's Layer provides one or many cameras which observe the scene as created in the Scene Layer. Using interaction rules a director can allow user interaction with the scene appearance, lighting or camera information, for example. Coherency information however cannot be modified by the user, as physical plausibility depends on coherency information. Finally, the user can observe a scene through the Director's Layer or make use of the defined interaction rules to modify scene content or its appearance.

FIG. 2 outlines the main steps of the method for selectively combining digital media objects, as described herein in accordance various embodiments of the present disclosure. The method allows for selectively combining acels, each acel being electronically stored as a digital file or digitally encoded from a source in real-time. In a first step 100, acels are selected from a set of available acels. This implementation provides an embodiment of the described Base Layer.

During a second step 200, a scene is described by specifying the positions of each selected acels in the scene. This corresponds to a basic embodiment of a Scene Layer. The Scene Layer can comprise further information such as coherency and lighting information as described above, or affine transformations that are to be applied to the generic acels as provided by the Base Layer. The acels can be statically positioned in the scene, or they can follow individually described trajectories within the scene over time.

During a third step 300, a description of at least one viewpoint in the scene is specified. This corresponds to a basic implementation of the described Director's layer. The Director's Layer can comprise further indications such as artistic effects that are to be applied to specific acels. The at least one viewpoint can be statically positioned in the scene, or it can follow a described trajectory within the scene over time.

The method ends after a combined digital media object has been generated. The combined digital media object represents the selected acels at their defined positions, possibly varying in time and space within the scene, as observed from the viewpoint.

The step of generating a combined digital media object can comprise the conversion of at least one selected digital media object from a first encoding format in which it was stored, into a second encoding format. Such conversion methods and algorithms are as such known in the art and will not be described in further detail in the context of the present description. If all the information relating to all selected acels is stored in a raw format, it can be possible to encode the combined data object in a single encoding step, which is most effective. Therefore the provision of unfiltered data simplifies the combination of data during this method step. Alternatively, it can be necessary to re-encode or transcode the information relating to at least some digital media objects. All user-defined processing effects will be applied during this step and prior to encoding.

The Base Layer comprises an arbitrary number of acels. All data contributing to the Base Layer is stored such that it can be non-ambiguously assigned to one scene. For example, all acel-related files can be located in a same folder on a storage medium. Acels in the Base Layer are addressed using unique identifiers. The naming convention is ideally such that acels can be easily added and removed from the base layer. This is for example done using hash values. In addition to the physically captured data, the Base Layer provides functionality to store additional metadata. This metadata can be used to reproduce the processing steps of the acel information (provenance information) and to recover the original data as recorded by an acquisition device. Provenance information is stored in a tree structure which is linked to the file header of an acel, thus providing the means to undo or redo processing steps. Ideally, all possible processing steps of the processing pipeline need to be known and identified. In order to ensure lossless storage, the original raw data can be linked to the acel by naming the respective source file in the acel header.

The Scene Layer manages the different physical components of a scene, which are stored in the Base Layer. The Scene Layer is responsible for laying out the multidimensional scene. In addition, the Scene Layer manages coherencies between acels. The scene layer thereby enhances commonly used scene graphs by coherency information. While the scene appearance block in FIG. 1 fulfills mainly the same purpose as a scene graph, coherency information in this layer is beneficial for assignment of semantics, user interactions and facilitation of processing steps. The coherency information also eliminates the necessity of a graph structure, as it imposes its own hierarchy and dependencies upon the underlying Base Layer information.

Each scene is uniquely identified (e.g. by an ID). All dimensions used in the scene which are required to be a superset of the acel dimensions need to be specified in the header of the scene. Acels are placed in a scene by giving the unique acel identifier and a specific position in all dimensions the scene is defined with. The following two cases are differentiated: 1) an acel is defined for the given dimension: the first entry of that acel is placed at the position defined in the scene layer, all other entries are considered relative to this first acel; and 2) an acel is not defined for the given dimension: the acel is constant in the given dimension with the value defined in the scene layer.

The scene layer can transform the whole acel, but not entries of an acel. All kinds of affine transformations (e.g. translation, rotation, sheering, expansion, reflection, etc.) on arbitrary acel dimensions are allowed.

Acel transitions that belong to the “physically” acquired data are stored in the Base Layer. However, explicit transition or transformation rules are described in the Scene Layer. The transition from one acel at time t to a different acel representing the same object at time t+1 can be given as an explicit rule in the Scene Layer.

Acels can be coherent to other acels. In addition, acels can be likely to be coherent to other acels. Coherencies are managed per dimension and assigned for each pair of acels. Assigning coherencies is not a requirement; the default value for all coherencies is ‘not coherent’ until specified differently. The coherency value is assigned on a scale from 0 to 1, where 0 designates no coherency and 1 rigid coherency (rigid coherency corresponds to being stored in the same acel). By assigning coherency values to groups of acels, a possibility to assign semantics to groups of acels or identify a common behavior to a group of coherent acels can be introduced. Furthermore, coherency imposes constraints on the acel modification. Whenever the appearance of an acel is modified the appearance of all acels coherent to this one will need to be adjusted accordingly.

When acels are placed in a scene, confidence information can be assigned to a whole dimension of an acel. If individual confidence values are assigned to the entries of an acel, this can be done as a further dimension of this acel containing the confidence information. Confidence can be used as a measurement to assign acquisition imprecision. In general, Base Layer data is assumed to represent the physical truth. However, due to imperfect acquisition tools a confidence measure in this data can either be assigned at acquisition time or during later processing steps.

There are several ways to express light in a scene. A light emitting object can exist as an acel. In this case, the light can be adjusted like all other acel dimensions from the scene layer. In addition to that, ambient lighting can be specified in the scene layer. If ambient light is used, this property is set in the scene header. If no light is specified, the default scene lighting is ambient lighting of a fixed strength. This default is only valid if no acel contained in the scene specifies a different light source and if no ambient light is specified in the scene.

The scene layer allows the storage of additional metadata for each Scene element, if available semantic information can be provided for the objects contained in a scene either manually or automatically. In addition, developer's information can be stored in the scene layer to facilitate postproduction.

The Director's Layer adds those elements that can be influenced by the director to a scene. Here one or many cameras (with position in a specific scene, field of view, capture time, focus, etc.) are defined, lights are positioned, filters are defined and rules are given which define further interaction with the scene layer.

One or multiple cameras can be defined. Each camera is defined by a set of parameters, which are set as explicit values. The set of parameters can be differentiated into intrinsic and extrinsic parameters. Cameras used to observe a scene do not become part of that scene, so another camera looking at the position of the first camera does not observe any object there.

Extrinsic camera parameters include:
Position X
Position Y
Position Z
Time

Intrinsic camera parameters include:
Focal Length
Image Format
Principal Point
Aperture
Exposure time
Filters

Per default, no user interaction with the scene content is allowed. If the director wants to specifically allow user interaction, a rule needs to describe the allowed interaction. Rules can allow any changes to the scene layer, e.g. affine transforms on all dimensions of acels or groups of acels. User interaction cannot alter the acels themselves contained in the base layer.

Therefore, a user can be permitted by rules to change the appearance of a scene, but he/she cannot change the physical content of a scene. A rule specifies a scene, an acel, a dimension and gives the range of allowed interaction. All acels that are coherent to the changed acel are affected by the change.

Along with user interaction rules comes the definition of separate user roles. In a movie production the director could, for example, wish to assign different interaction possibilities to broadcasters and viewers (example: broadcaster updates movie-internal advertising, viewer interacts with viewpoint). User role definitions are set by defining user groups with IDs and relating to these IDs when the rules are defined.

In addition to the metadata information stored in the Base Layer and Scene Layer, the Director's Layer provides the option to store metadata as well. This metadata can contain interface information for the user interaction (like a help file), and other information relevant to be linked to the whole production.

FIG. 3 illustrates a device 10 that is capable of implementing the method for selectively combining digital media objects, as described herein in accordance various embodiments of the present disclosure. The device 10 comprises at least one memory element 12 and processing means 14. The processing means 14 are configured to load and read a description 16 of a scene from a data file 18 stored in a storage element 20 into the memory element 12, and to load at least one acel 22 specified in the scene description 16 from a storage element 24 that stores Base Layer data into the memory element 12. Additionally, the processing means 14 are configured to generate a combined digital media object 26 that represents the selected acels 22 at positions that are specified in the scene description 16, as observed from viewpoint defined in the Director's Layer, and to store the combined digital media object 26 in the memory element 12.

In various embodiments, the description 16 is hierarchically structured, and comprises a description for each acel 22, including a unique identifier, a storage location where the acel data can be retrieved, and any metadata that is applicable to the acel 22 on the scene level.

The storage elements 20 and 24 can be local storage elements that are a part of the computing device 10 that comprises the memory element 12 and the processing means 14. Alternatively the storage elements 20 and 24 can be networked storage elements that are accessible by the device 10 through a network infrastructure. Such variants and means to implement them are as such known in the art and will not be described in any further detail in the context of the present disclosure.

In various embodiments there is provided an application programming interface, API, that provides access to the heterogeneous stored acels 22 through unified API function calls. This provides the flexibility of adding different types of media to the SRA, provided that an appropriate access method is implemented.

A few of the numerous benefits of an API are:
Extendibility: in the future further functions and necessities can be easily added. If a certain way of accessing scene data is needed, only a function needs to be added to the API. The underlying file structure is not affected by such enhancements.
Flexibility: an API allows exchanging the underlying file structure easily without affecting the tools and algorithms that already employ scene data.
Creativity: the scene API is designed to facilitate module contributions and therefore enhance the creativity of its users. Adding new computational modules for further algorithmic processing of scene content or adding new tools with currently unknown requirements within read of the skilled person. An API therefore boosts the creativity of developers and producers at the same time.

It should be understood that the detailed description of specific preferred embodiments is given by way of illustration only, since various changes and modifications within the scope of the disclosure will be apparent to the skilled man. The scope of protection is defined by the following set of claims.

What is claimed is:

1. A computer-implemented method for selectively combining digital media objects, each digital media object being electronically stored as a digital file or digitally encoded from a source in real-time, said method comprising:
selecting digital media objects, each digital media object representing media in one or more dimensions, from a set of provided digital media objects;
providing a description of a virtual space, a dimensionality of the virtual space being at least equal to the highest dimensionality of any of the selected digital media objects, the description further specifying the positions of each selected digital media object in the virtual space;
providing a description of a viewpoint in the virtual space; and
subsequently generating a combined digital media object, which represents the selected digital media objects at their defined positions in the virtual space, as observed from the viewpoint.

2. The method of claim 1, wherein providing the description of a virtual space comprises specifying how the selected digital media objects dynamically evolve in the virtual space over a specified time period.

3. The method of claim 1, wherein providing the description of a virtual space comprises specifying properties for each digital media object, comprising their size or an affine transformation, the properties being applied to the digital media objects during the step of generating a combined digital media object.

4. The method of claim 1, wherein providing the description of a virtual space comprises specifying metadata for each selected digital media object.

5. The method of claim 1 further comprising at least one of electronically storing and encoding from a source in real time each digital media object at the best available quality.

6. The method of claim 5 further comprising at least one of electronically storing and encoding from a source in real time each digital media object at a quality level incurring low or no signal losses.

7. The method of claim 1 further comprising specifying, for at least one selected digital media object, a signal processing effect that is applied to the digital media object during the step of generating a combined digital media object.

8. The method of claim 1 further comprising specifying, for the virtual space as viewed from the viewpoint, a signal processing effect that is applied during the step of generating a combined digital media object.

9. The method of claim 1, wherein providing the description of a viewpoint in the virtual space comprises specifying at least one of intrinsic and extrinsic parameters of a virtual camera located at the viewpoint, the parameters being applied to the viewpoint during the step of generating a combined digital media object.

10. The method of claim 1, wherein selecting digital media objects comprises selecting at least one of image objects, video objects, still animated computer-generated objects, and animated computer-generated objects.

11. The method of claim 1, wherein providing a description of a virtual space comprises defining the description of virtual space using a hierarchical data structure.

12. The method of claim 1, wherein generating the combined digital media object comprises converting at least one selected digital media object from a first encoding format in which it was stored, into a second encoding format.

13. The method of claim 1 further comprising rendering a graphical representation of the generated combined digital media object.

14. A device structured and operable to selectively combining digital media objects, each digital media object being electronically stored as a digital file or digitally encoded from a source in real-time, said device comprising:
at least one memory element; and
a processing means, the processing means structured and operable to:
load and read a description of a virtual space from a data file stored in a storage element into the memory element;
load at least one digital media object specified in the description from a storage element into the memory element;
generate a combined digital media object that represents the selected digital media objects at positions that are specified in the description, as observed from a specified viewpoint; and
store the combined digital media object in the memory element.

15. The device of claim 14, wherein the device further comprises a user interface structured and operable to enable a user to modify the description of the virtual space prior to generating a combined digital media object.

16. The device of claim 14, wherein the processing means are further structured and operable to render a representation of the combined digital media object on a display operatively connected to the device.

17. The device of claim 14, wherein the processing means are further structured and operable to store the combined digital media object on a storage element.

18. A computer structured and operable to selectively combining digital media objects, each digital media object being electronically stored as a digital file or digitally encoded from a source in real-time, said computer comprising:
at least one memory element; and
a processing means, the processing structured and operable to:
load and read a description of a virtual space from a data file stored in a storage element into the memory element;
load at least one digital media object specified in the description from a storage element into the memory element;
generate a combined digital media object that represents the selected digital media objects at positions that are specified in the description, as observed from a specified viewpoint; and
store the combined digital media object in the memory element.

19. A computer program comprising computer readable instructions executable by a computer for performing the steps of:
selecting digital media objects, each digital media object representing media in one or more dimensions, from a set of provided digital media objects;
providing a description of a virtual space, a dimensionality of the virtual space being at least equal to the highest dimensionality of any of the selected digital media objects, the description further specifying the positions of each selected digital media object in the virtual space;
providing a description of a viewpoint in the virtual space; and
subsequently generating a combined digital media object, which represents the selected digital media objects at their defined positions in the virtual space, as observed from the viewpoint.

20. A computer program product comprising:
a processing means; and
a computer-readable medium having stored thereon a computer program comprising computer readable instructions executable by the processing means for performing the steps of:
selecting digital media objects, each digital media object representing media in one or more dimensions, from a set of provided digital media objects;
providing a description of a virtual space, a dimensionality of the virtual space being at least equal to the highest dimensionality of any of the selected digital media objects, the description further specifying the positions of each selected digital media object in the virtual space;
providing a description of a viewpoint in the virtual space; and
subsequently generating a combined digital media object, which represents the selected digital media objects at their defined positions in the virtual space, as observed from the viewpoint.
